(19) United States
(12) Patent Application Publication
(10) Pub. No.: US 2007/0102998 A1
(43) Pub. Date: May 10, 2007

(54) Method and system for distributing power across an automotive network

(76) Inventors: Patrick D. Jordan, Austin, TX (US); Hai Dong, Austin, TX (US); Walton L. Fehr, Mundelein, IL (US); Hugh W. Johnson, Cedar Park, TX (US); Prakash U. Kartha, Round Rock, TX (US); Donald J. Remboski, Akron, OH (US)

Correspondence Address: MOTOROLA, INC., 1303 EAST ALGONQUIN ROAD, IL01/3RD, SCHAUMBURG, IL, 60196, US

(21) Appl. No.: 11/268,872

(22) Filed: Nov. 8, 2005

(51) Int. Cl. B60L 1/00

(52) U.S. Cl. 307/9.1

(57) ABSTRACT

Nodes which include additional sensing and communication capability as compared to prior nodes. The sensing capability allows determination of actual current flows through the particular nodes, including each port of the node, to allow a determination of power flow to better control operations. Because of this understanding of power flow, smaller modules or nodes can be utilized if desired. For protection of a lower power node, an upstream node can open the link to the node should it go overcurrent or otherwise fault. Further, with the additional sensing capability, actual load balancing and multiple controllable flows, such as for standby, can be developed. The additional communication in combination with the sensing also allows better fault isolation. By being able to determine the actual location of the fault, other operations in the vehicle can continue with just the faulty area being disconnected.

### RELATED CASES

This patent application is related to U.S. patent application Ser. No. 10/439,702, entitled “Power and Communication Architecture for a Vehicle,” filed May 16, 2003, which is hereby incorporated by reference.

### FIELD OF THE INVENTION

This invention relates to vehicles, and more particularly to a power architecture for a vehicle.

### BACKGROUND OF THE INVENTION

Vehicles have been getting ever more complex with the advances in computer technology. Sensors are becoming more intelligent and actuators are becoming increasingly controlled by microcomputers. The number of microcomputers inside a vehicle has greatly proliferated, so that effectively each sensor or actuator, as well as the various interactive devices such as entertainment systems, all include microcomputers. Because of this proliferation, serial communication networks have been developed for use inside the vehicle to simplify overall operation. These exist according to various standards depending on both region and particular manufacturer. Nonetheless, a general communication architecture has been developed. However, power distribution throughout the vehicle has remained at existing levels of wiring and fusing arrangements, with complicated wire looms which are expensive to build, install and repair.

In the patent application referenced above, it was proposed to build a modular architecture for both communications and power, with various switching nodes to switch both the communications and the power. In this manner the wiring of a vehicle can be dramatically simplified to a few standardized links or cables based on particular power requirements, with each link having power and communication portions. While the architecture of the referenced patent application does provide significant benefits, the actual power distribution scheme was relatively simplistic in that each of the nodes would only monitor for faults and otherwise would simply provide power. As a result of this simplistic approach, each of the modules would effectively have to be designed for similar power levels, such as high power levels, and so would require expensive components. In many cases it would be more desirable to use lower cost components, i.e., for lower power applications, but the limited and simplistic design of the prior art system does not provide for this capability. Each portion of the system must be designed for a worst case maximum load environment, so lower cost improvements effectively can not be used. Therefore it would be desirable to be able to provide more control of the distribution of power within a node architecture in a vehicle to allow use of lower cost components.

### DESCRIPTION OF THE FIGURES

FIG. 1 is an illustration of a vehicle indicating exemplary nodes and power wiring.

FIG. 2 is a simplified block diagram illustrating a first embodiment of nodes and switched power flow.

FIG. 3 adds standby power capabilities to the embodiment of FIG. 2.

FIG. 4 is a block diagram of a node useful in the architecture of FIG. 2.

FIG. 5 is a block diagram of a node, similar to FIG. 4 except that standby power as used in FIG. 3 has been incorporated.

FIGS. 6A-6D are schematic diagrams of switching points contained in the nodes of FIGS. 3 and 4.

FIGS. 7A-7C illustrate the network of FIG. 2 with various fault conditions.

FIG. 8 is an illustration of the network of FIG. 2 with alternate paths available at particular nodes.

FIG. 9 is a variation of FIG. 2 with a dual power source arrangement.

FIG. 10 is a variation of FIG. 2 with a high and low voltage source arrangement.

FIGS. 11A-11D illustrate various load flows and load balancing capabilities of a system according to the present invention.

FIG. 12 illustrates an ordering hierarchy for use in fault detection according to the present invention.

FIG. 13 is a flow chart of initialization operations of an architecture according to the present invention.

### DETAILED DESCRIPTION OF THE PRESENT INVENTION

Nodes according to the present invention include additional sensing and communication capability as compared to prior nodes. The sensing capability allows determination of actual current flows through the particular nodes, including each port of the node, to allow a determination of power flow to better control operations. Because of this understanding of power flow, smaller modules or nodes can be utilized if desired. For protection of a lower power node, an upstream node can open the link to the node should it go overcurrent or otherwise fault. Further, with the additional sensing capability, actual load balancing and multiple controllable flows, such as for standby, can be developed. The additional communication in combination with the sensing also allows better fault isolation. By being able to determine the actual location of the fault, other operations in the vehicle can continue with just the faulty area being disconnected.

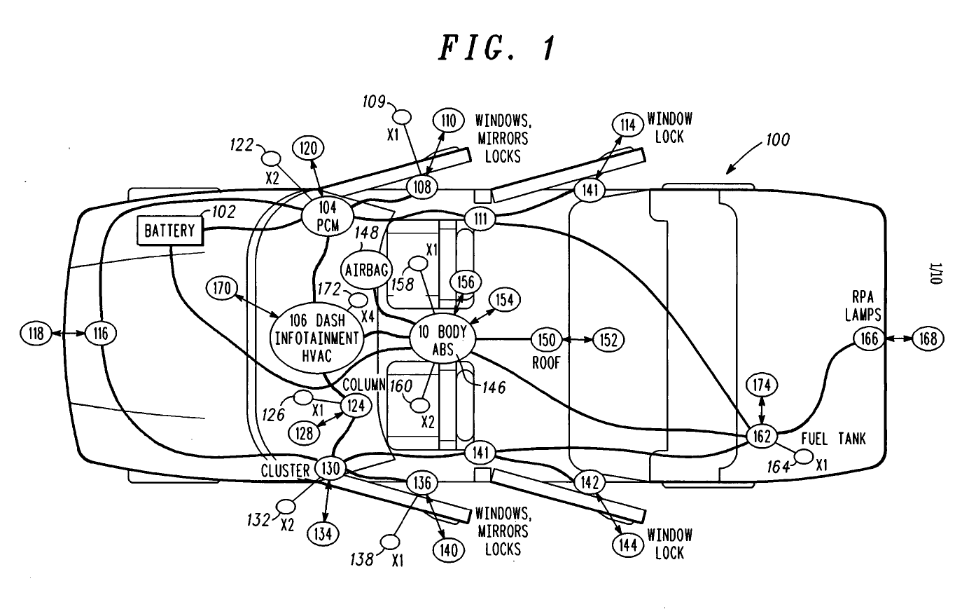

Referring now to FIG. 1, an illustration of a typical vehicle 100 is shown. A battery 102 forms the representative power source, it being understood that the actual power source would be some combination of a battery, an alternator and/or a super capacitor. Shown connected to the battery 102, directly or indirectly, are a series of ovals which represent the various control and power nodes or modules in the vehicle 100. These nodes can be complex, such as computing/switching/control nodes; intermediate, such as smart switches; or simple, such as sensors or actuators. Each node may have direct inputs and outputs to devices and switches which are not shown for simplicity. The complex nodes will have greater computing capacity and handle more complex tasks, while intermediate nodes have less computing capacity and handle simpler tasks. Simple nodes have the least computing capacity, effectively only enough to perform the required communication, and handle simple, usually digital, devices. For example, a powertrain control module (PCM) 104 is connected to the battery 102. In conventional parlance the PCM 104 is a complex node and controls the engine and transmission of the vehicle 100. The PCM 104 is connected to a dash entertainment and ventilation module 106. The dash entertainment and ventilation module 106 is also a complex node and is typically behind the dash in the vehicle 100 and controls the various information, entertainment and heating and ventilation controls that are present in the dashboard. Further connected to the PCM 104 is a right front door node 108. The right front door node 108, for example, controls the power window, power mirror and door lock for the right passenger door. Connected to the right front door node 108 is an actuator 110 which is, for example, contained in the right front door to control the power window and door lock. A controller 109 is located in the right front door and connected to the right front door node 108 to allow the right front door node 108 to control the power mirror. A right rear door node 112 is connected to the PCM 104 through a switch node 111 and is also connected to an actuator 114 which controls the power window and lock. An engine compartment node 116 is connected to the PCM 104 and is also connected to actuator 118. In addition, an actuator 120 is connected to the PCM 104 as are two controllers 122.

In the illustrated vehicle 100, a steering column node 124, an intermediate node, is connected to the dashboard module 106. A controller 126 is connected to the steering column node 124, as is an actuator node 128. A driver's side node 130, also an intermediate node, is connected to the steering column node 124. Controllers 132 and actuator node 134 are connected to the driver's side node 130. Additionally connected to the driver's side node 130 is a front left door node 136, which in turn receives a controller 138 and an actuator 140. In addition, a left rear door node 142 is connected to the driver's side node 130 through a switch node 141 and is connected to an actuator 144. The driver's side node 130 is also connected to the engine compartment node 116 to provide a parallel path for switching purposes.

The next major node in the vehicle is the body and ABS module 146, which is a complex node and is connected to both the battery 102 in the illustrated embodiment and to the dashboard module 106. An airbag control node 148 is connected to the body and ABS module 146 to perform the airbag functions necessary in the car. A roof node 150 is also connected to the body and ABS module 146 to control items such as the sunroof and the lighting and to that end an actuator 152 is connected to the roof node 150. Various other actuators 154 and 156 are connected to the body and ABS module 146. Controllers 158 and 160 are also connected to the body and ABS module 146, for example to control the power seats. A fuel node 162, an intermediate node, is further connected to the body and ABS module 146 and is connected to a controller 164, which may be a fuel pump for example. A rear body node 166 is connected to the fuel tank node 162 and links to an actuator 168 to control, for example, the rear lamps. The fuel tank node 162 is also connected to the switch nodes 111 and 141 to provide additional parallel paths.

An actuator 170 and controllers 172 are also connected to the dashboard module 106.

Each of the links between the particular nodes or modules is uniform in a first embodiment and includes a power cable, a ground cable and communications cables, as necessary, for the particular communication protocol. The links between the various nodes, actuators and controllers would also be similar in that they would contain power, ground and communications links though, in some embodiments of the present invention, the links could have different size power and ground conductors, for example, in that a sensor may require less power than an actuator node and various actuator nodes could require less power than other actuator nodes. In alternate embodiments, power line communications technique are used, so the links include only power and ground cables, the communications signals being provided over the power cable.

Thus it can be seen that a switching network is developed in the vehicle for both communications and power.

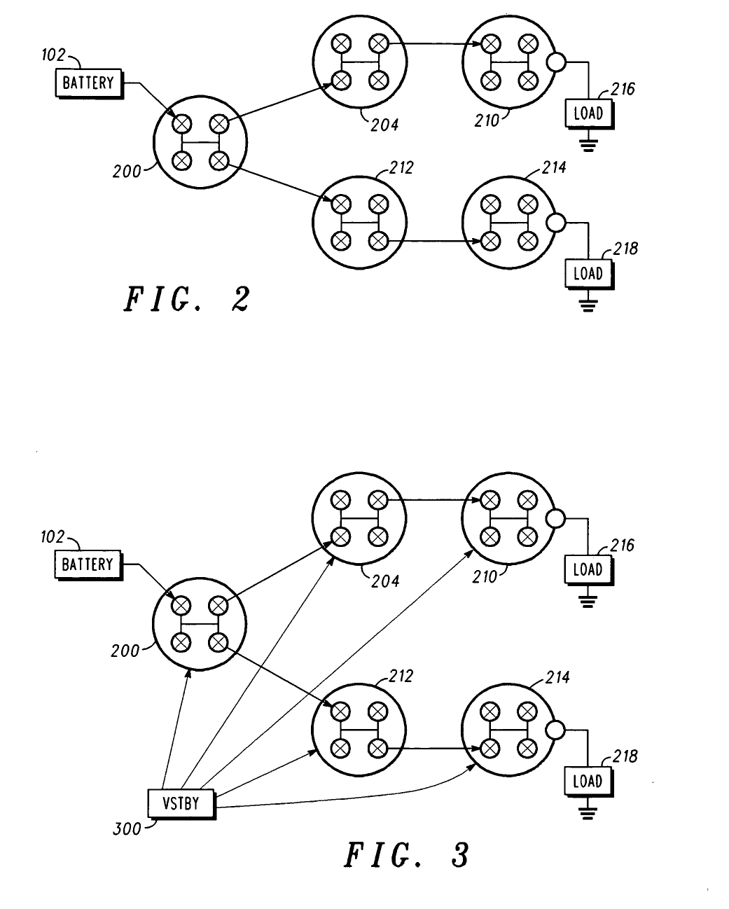

This switching network for power is more clearly seen in FIG. 2. The battery 102 is connected to a first illustrative node 200. The node 200 is similar to the nodes illustrated in FIG. 1 but in this case is shown in a simplified format. Each illustrated node has four ports to receive cables to form links. The battery 102 is connected to node 200 at a first input port. A second node 204 is connected to a second port of the node 200 at its own first port. In turn, an additional node 210 is connected to the second port of the node 204 at its own first port. Similarly, a node 212 is connected to a third port of the node 200 through its first port. Then a node 214 has its first port connected to a second port of the node 212. An exemplary load 216 is connected to the node 210 and a load 218 is connected to the node 214. Thus, in the example of FIG. 2, power flows from the battery 102 through node 200 to node 204 to node 210 and to the load 216. Similarly, power flows from the battery 102 through the node 200 through the node 212 and through the node 214 to the load 218.

FIG. 3 is similar to FIG. 2 except that a standby voltage source 300 has been connected to each of the nodes 200, 204, 210, 212 and 214.

A block diagram of a node as used in FIG. 2 is shown in more detail in FIG. 4. A node 400 contains various components. For example, the node 400 contains first, second, third and fourth power connections 402, 404, 406 and 408. The node 400 contains data connections 410, which preferably includes four connections, one to be paired with each power connection, each connection including various conductors as appropriate for the communications network. The node 400 contains a ground connection 412, which is generally tied to vehicle ground and also preferably paired with the power connections so that four ports are developed for the node 400. In the embodiment of FIG. 4, the node 400 not only provides power and communication switching capabilities, it also has the capability to provide and directly drive loads. Thus a first load 414 is connected to the node 400. As this is a highside load, both sides of the load 414 are connected to the node 400, one to receive power and one to a lowside driver 434. For a lowside load 416, the lowside load 416 is simply connected directly to a highside driver 432 in the node 400, with the other connection of the load 416 being connected to ground.

Each of the power connections 402 to 408 is connected to power switches 422, 424, 426 and 428. While these will be described in more detail below, effectively these are switching points to control power flow, either power into or power out of, or in some cases both, of the particular connection. The second power sides of the four switches 422-428 are connected together to form a central power point or bus 430. This central power point 430 is connected to the highside load 414 and to the highside driver 432. A voltage regulator 436 is connected to the central power point 430 and to ground 412 to provide a controlled voltage environment for the node 400. Finally, a microcontroller 438 is connected to the various power switches 422, 424, 426 and 428, the voltage regulator 436 and the drivers 432 and 434, as well as the data connections 410 to provide overall communication and control capability to the node 400. Each switch 422, 424, 426 and 428 further has a sense connection to the microcontroller 438, preferably through an analog to digital interface, and has a control or switch connection to the microcontroller 438 to allow control of the operation of the switches 422, 424, 426 and 428.

If power line communications are used, the external data connections 410 are not present, but an interface module is present and is connected between the respective power connection and the microcontroller 438.

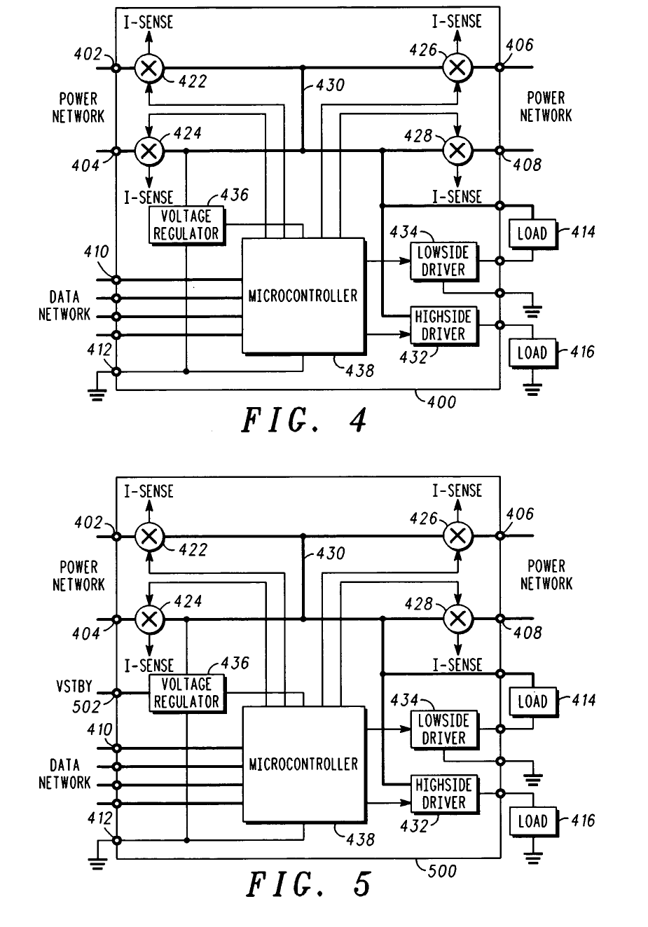

FIG. 5 similarly shows a node 500 with like parts from node 400 being similarly numbered. The addition to the node 500 is a standby connection 502 to receive the standby voltage from the standby voltage source 300. This standby voltage connection 502 is connected to the voltage regulator 436 to provide an alternate source of voltage to the node 500 when the main battery 102 is not coupled to the node 500.

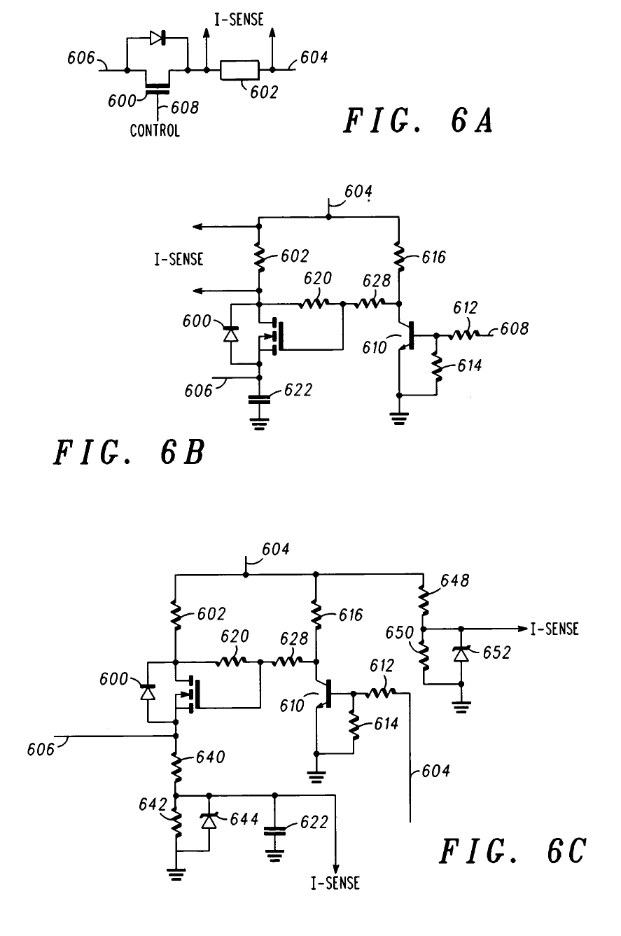

FIGS. 6A-6D are more detailed drawings of the switches 422, 424, 426, 428. The differences between the FIGS. 6A-6D are in capabilities of the particular functions of the switch node. FIG. 6A is a simplified schematic version, with just a transistor 600 in series with a sense resistor 602, with the current sense being measured across the sense resistor 602 and the transistor 600 having a control or gate input 608. This simple switch format is useful in many cases, particularly those where the actual node will only be a downstream device and the only items downstream are actuators, with no situations for reverse flows of power. A power input terminal 606 is connected to connection 402 and a power output terminal 604 is connected to the central power point 430, for example.

FIG. 6B is a more detailed schematic of the switch of FIG. 6A. FIG. 6B includes primarily more details on the control or gate circuitry. The base of an NPN transistor 610 is connected to the control input 608 through a series resistor 612. A resistor 614 is connected from the base of the transistor 610 to ground and to the emitter of the transistor 610. The collector of the transistor 610 is connected to the output power terminal 604 through a resistor 616 to provide pull up capability. The collector of the transistor 610 is also coupled through the series of connection of resistors 618 and 620 to the drain terminal of the transistor 600 and to one end of the current sense resistor 602. The connection point between the resistors 618 and 620 is connected to the gate input of the transistor 600. As before, the source of the transistor 600 is connected to the power input terminal 606. A capacitor 622 is connected between the power input terminal 606 and ground to provide filtering.

FIG. 6C is a similar detailed schematic of a switch. The switch of FIG. 6C is slightly different from that of FIG. 6B in that the current sense lines are developed in a slightly different format. Instead of taking signals from both sides of the sense resistor 602, in the embodiment of FIG. 6C ground-referenced voltage levels from the input and output sides are provided. On the power input side a first resistor 640 has an end connected to the power input terminal 606 and the source of the transistor 600. The other end of resistor 640 is connected to one end of a resistor 642, which is also connected to ground. The connection point of the resistors 640 and 642 is one signal of the pair used for current sensing. In one embodiment of the present invention, a Zener diode 644 is connected across the resistor 642 for protection purposes, as is a capacitor 646. A resistor 648 has one end connected to the power output terminal 604 and the second end connected to the first end of a resistor 650, whose second end is connected to ground. A Zener diode 652 is connected in parallel with the resistor 650. As before, the connection point between the resistors 648 and 650 is one portion of the I or current sense signal, so that the actual sensing for current flow through the switch is determined by measuring the voltage difference between the two current sense signals, there being a predetermined amount of resistance between the power input terminal 606 and power output terminal 604.

While the embodiments of FIG. 6A-6C were simple embodiments which are generally used for more downstream applications, the embodiment of FIG. 6D provides full input and output power control. The switch 654 of FIG. 6D has a common power connection 656, which would be connected to central power point 430 in the node of FIG. 4, for example. It also has an input or output (I/O) power connection 658, which for example would be connected to connection 402 on the node 400. A ground connection 660 is provided. As both input and output control are available on the switch 654, output control connection 662 and input control connection 664 are provided. Similarly, there is an output current sense signal 666 and an input current sense signal 668. In one embodiment, highside power switches 670 and 672 such as the BTS 6143D are used in place of the simple FETs illustrated in FIGS. 6A-6C. The VBB or supply voltage input to this switch 670 is connected to the common power connection 656. The VBB or supply voltage input of the switch 672 is connected to the I/O power connection 658. The output voltage signals of the two switches 670 and 672 are connected together. Further connected to this common point are a pair of Schottky diodes 674 and 676. The anodes of the two diodes 674 and 676 are connected to the outputs of the switches 670 and 672. The cathode of the diode 674 is connected to the common power connection 656, while the cathode of the diode 676 is connected to the I/O power connection 658.

The output control connection 662 is provided to one side of a resistor 678 and the second side is connected to one side of a resistor 680 and the base of an NPN transistor 682. The second side of the resistor 680 is connected to the emitter of the transistor 682 which is connected to ground. The collector of the transistor 682 is connected to the control input connection of the switch 670.

The input control of the switch 672 is more complicated because of the need to supply power to the microcontroller 438 even though the input power is disabled. The input control connection 664 is connected to the first end of a resistor 684 whose second end is connected to the first end of a resistor 686 and the base of an NPN transistor 688. The emitter of the transistor 688 and the second end of the resistor 686 are connected to ground. The collector of the transistor 688 is connected to one end of a resistor 690, whose second end is connected to the I/O power connection 658. A resistor 692 has one end connected to the I/O power connection 658 and the second end connected to a voltage sense connection 694. The voltage sense connection 694 is also connected to one end of the capacitor 696, whose other side is connected to ground. Further, the voltage sense connection 694 is connected to one end of a resistor 698 whose second end is connected to the collector of an NPN transistor 700 and one end of a resistor 702. The second end of the resistor 702 and the emitter of the transistor 700 are connected to ground. The collector of the transistor 700 is connected to the first end of a resistor 704, whose other end is connected to the I/O power connection 658. The collector of the transistor 700 is also connected to one end of a resistor 706, whose second end is connected to the base of an NPN transistor 708 and one end of a resistor 710. The second end of the resistor 710 and the emitter of the transistor 708 are connected to ground. The collector of the transistor 708 is connected to the collector of the transistor 688. This collector connection is also connected to one end of a resistor 712 whose second end is connected to the base of an NPN transistor 714 and one end of a resistor 716. The second end of the resistor 716 is connected to the emitter of the transistor 716 and is connected to ground. The collector of the transistor 714 is connected to the control input of the switch 672.

The circuit can be simplified to just the resistors 712 and 716 and transistor 714 if the schematic of FIG. 4 is modified to include diodes bypassing the switches 422-428 to provide power to the voltage regulator 436.

The output current sense connection 666 is connected to the current sense pin of the switch 670, which is connected to one end of a resistor 718, which has its other end connected to ground. Similarly, the input current sense connection 668 is connected to the current sense pin of the switch 672 and connected to one end of a resistor 720, whose other end is connected to ground.

With the switch 654 properly controlling the input and output control connections 662 and 664, this allows full bidirectional control of power flow through the switch if desired, rather than the one-way flow of the prior switch embodiments.

It is understood that FIGS. 6A-6D are specific embodiments and there are many other possible embodiments.

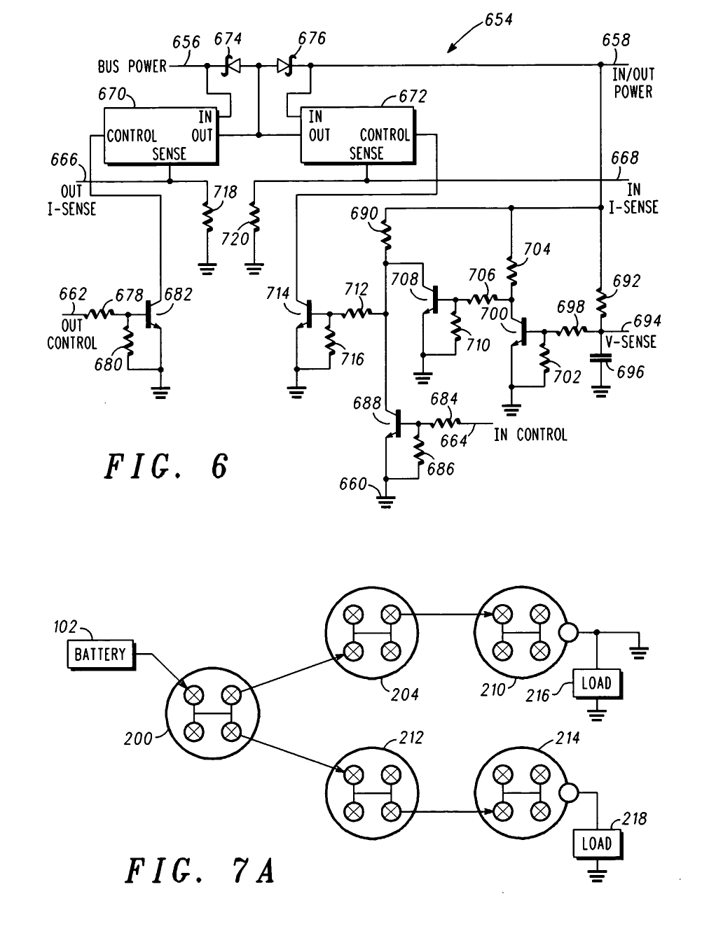

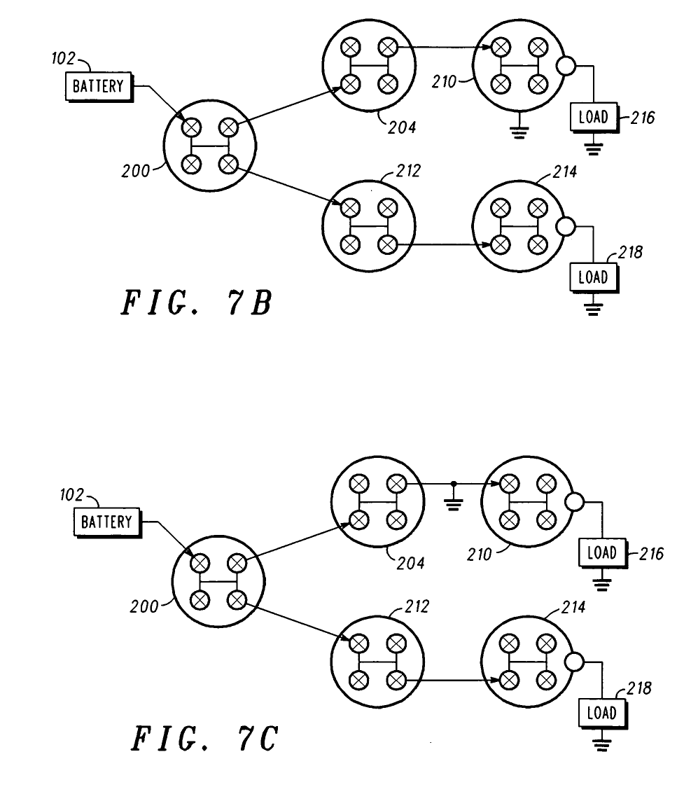

FIGS. 7A, 7B and 7C show three different fault conditions for the network of FIG. 2. In FIG. 7A, there is a fault to ground at the load 216. In FIG. 7B the node 210 itself has a fault to ground, while in FIG. 7C the link connecting nodes 204 and 210 is faulted to ground. By properly monitoring the various load currents in the various locations, such as the output power ports of switch nodes 204 and 210, a determination of the location of the fault can be developed. As there is a switched communication path between all nodes, with the microcomputer 438 in each node performing the data switching function, the various nodes can communicate their fault conditions to each other to determine the fault location. Once the location is determined, then the appropriate switch can be turned off via node 204 or node 210 to alleviate the problem.

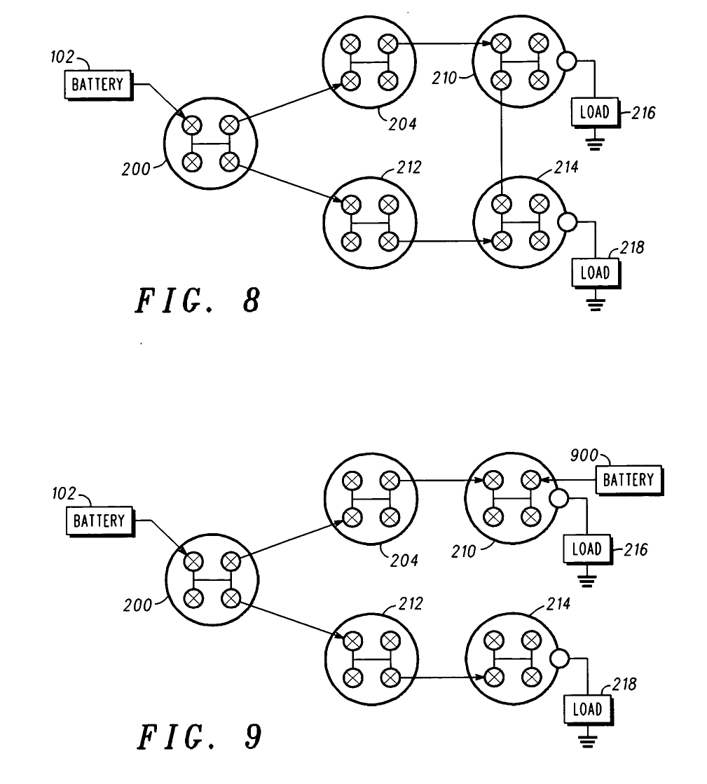

FIG. 8 illustrates a link between the nodes 210 and 214 to allow multiple routing of power in the case of a fault. For example, should node 204 fail or the links to and from node 204 fail, power can ultimately in this case be routed from node 214 to node 210, rather than having node 210 rely only on node 204 for its power source. This use of interconnection and redundant connections provides great redundancy and failover capabilities for the network. Several examples of these redundant or parallel connections are provided in FIG. 1.

FIG. 9 has an exemplary second battery 900 connected to the node 210 so that two batteries i.e., two power sources as discussed above, are present in the network of FIG. 9. In this case power can then flow from node 210 to node 204, if desired, instead of flowing only from node 200. Alternatively, the link between nodes 200 and 204 can become a redundant link and utilized if there is a failure in the battery 900, the node 210 or the links between them.

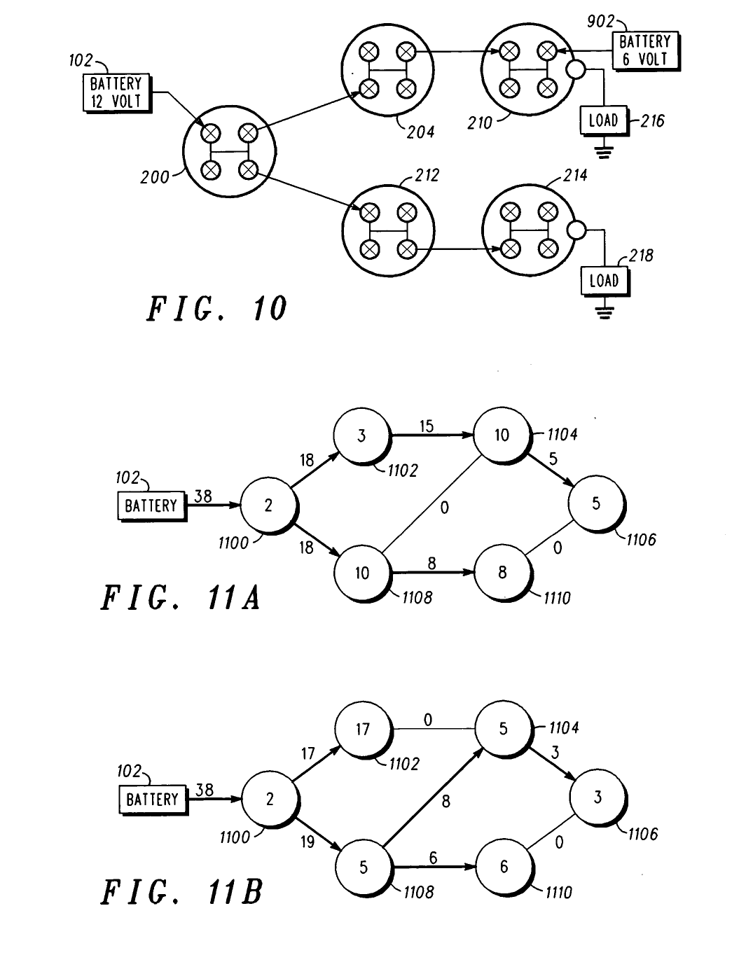

In FIG. 10 a battery 902 connected to node 210 is noted as being at a lower voltage, such as six volts. This provides standby capability or multiple voltage operation if desired. For example, if full power operation was over and the vehicle was turned off, a backup or standby power capacity could be developed using the battery 902 by properly rerouting the power flow to be from battery 902 instead of battery 102 by enabling the proper nodes.

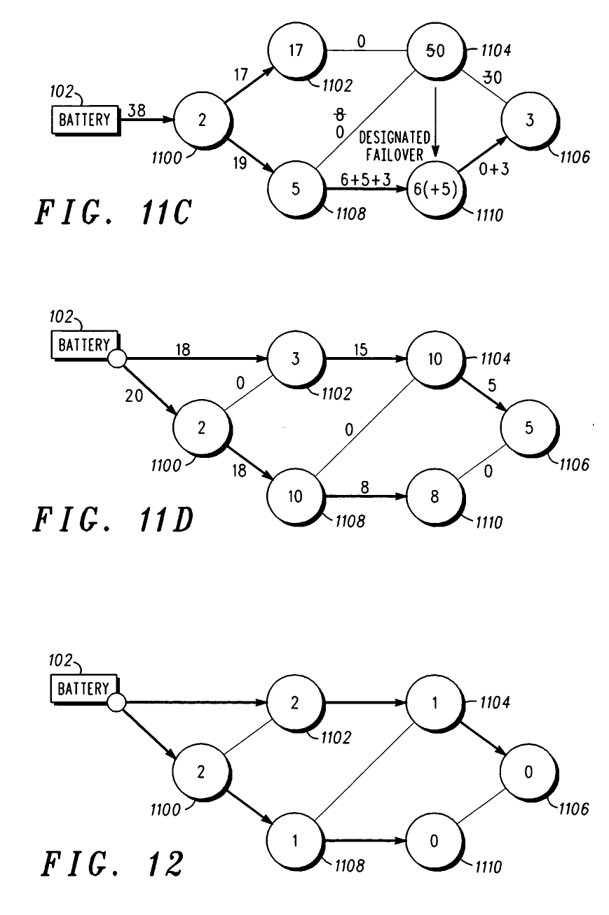

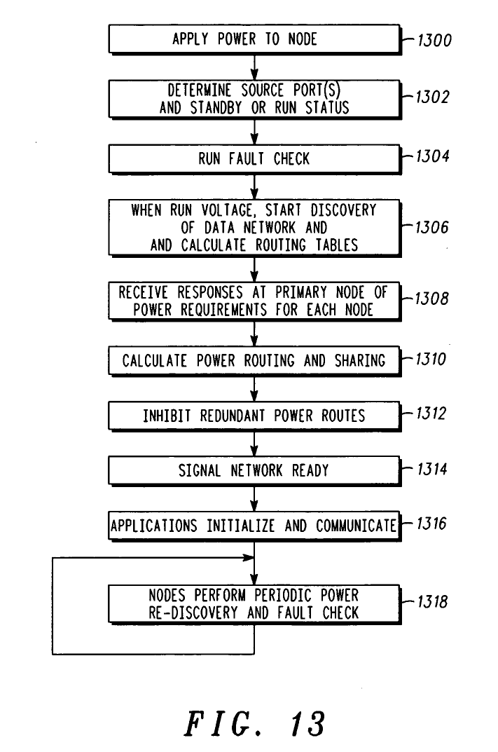

One major advantage of the nodes of the present design is the capability to power balance and to reroute power in case of failures. FIGS. 11A, 11B, 11C, and 11D illustrate various aspects of power balancing and rerouting. In FIG. 11A, the battery 102 is providing a total of 38 amps to node 1100. Two amps are used by node 1100, either internally or to components directly connected to node 1100. Eighteen amps are then provided to node 1102, which uses three amps and provides the remaining fifteen amps to node 1104. Node 1104 uses ten amps and provides the remaining five amps to node 1106. Eighteen amps are also provided from node 1100 to node 1108, which uses ten amps and provides eight amps to node 1110. Node 1110 uses the eight amps it receives from node 1108. No current flows in the links from node 1108 to node 1104 and from node 1110 to node 1106, so these links are switched off or opened.

In FIG. 11B the loads used at the various nodes change. Node 1102 now uses seventeen amps, node 1104 uses five amps, node 1106 uses three amps, node 1108 uses five and node 1110 uses six amps. To keep the flows from node 1100 balanced, seventeen amps are provided from node 1100 to node 1102, with nineteen amps from node 1100 to node 1108. No current can be provided from node 1102 as it uses all seventeen amps it receives. Instead, node 1104 receives eight amps from node 1108, over the previously unused link. Node 1104 then provides three amps to node 1106. Node 1108 provides the remaining six amps to node 1110. Now, the link between nodes 1102 and 1104 is unused and can be opened. As can be seen, the load flows in the network have been changed to remain substantially balanced.

In FIG. 11C, it is assumed that either nodes 1104 or 1110 can provide five amps to an actuator. Normally the power is supplied from node 1104 but in FIG. 11C, node 1104 is treated as having failed, so node 1110 must begin driving the actuator and also providing power to node 1106. As a result, the load flows change to have the additional five amps flow from node 1108 to node 1110 for the actuator and an additional three amps for node 1106. Thus this first failover situation is readily handled by the network.

In FIG. 11D, node 1102 is also connected to the battery 102. Thus the eighteen amps from node 1100 to node 1102 in FIG. 11A is provided directly from the battery 102 so that the link between node 1100 and node 1102 carries no power and can be opened.

Loads carried over a link and provided to the various devices can be determined several ways and then are used to perform the load balancing. The most direct way is by monitoring the current at each port using the current sense capabilities of each switch and then summing the results to determine internal current consumption. Detection for individual loads can be done by momentarily strobing the load and monitoring current during the on and off periods. Additionally, changes can be monitored as loads are activated, thus allowing a direct reading.

Ultimately each load can be determined by each node and the results provided to a primary control node. This node will know the topology of the network and be able to instruct the proper nodes to enable or disable selected ports.

The current distribution can be determined in several manners. As one example, a full true analysis can be performed for all possible arrangements. As a second example, a trial and error approach can be used where links are activated or deactivated and the resulting current balance measured until a desired balance is achieved. Other techniques known to those in the art, such as a variation on Dijkstra's algorithm where currents are the weighting factors or others, may be used as well.

This power routing can also be done dynamically by each node providing messages to the primary node before turning loads on or off, thus allowing the primary node to prepare for load increases or decreases. Alternatively, each node can periodically repeat the load calculations discussed above.

FIG. 12 illustrates a hierarchy of nodes to enable improved fault detection and containment. In one embodiment of the present invention, nodes which are directly connected to the battery are considered source nodes and have the highest hierarchal number. Nodes directly connected to those nodes have a lower hierarchal number and so on until you reach nodes which are the farthest from the source nodes and the battery. To perform fault isolation, control actions are taken, first at the farthest nodes, i.e., those with the lowest hierarchy number, to determine if containment can be developed at that level. Containment moves back one hierarchy level at a time to determine the node which can correct or alleviate the fault with the least number of other side effects. This is preferably done by delaying the trip time after detecting a fault by a factor based on the hierarchy level of the node. Alternatively, as discussed above, the various nodes can also pass fault messages over the communication network to try and isolate the fault based on sensed fault information.

Fault detection can occur in various manners. The most direct is by sensing currents over a given limit to indicate a downstream fault. An internal or directly connected fault can be determined by summing currents into and out of the node and determining if the difference exceeds the expected directly connected and internal loads. Profiling can be used, where the turn on and off characteristics of a load are monitored for deviations from normal. Of course, other methods as known to those in the art can be used.

Because this is a distributed network generally powered from a single power source with power being delivered through the switching components, it is necessary to have a power initialization protocol. A simple protocol or flowchart is shown in FIG. 13. In step 1300 power is applied to a node, such as when the battery is connected or the vehicle is turned on. In step 1302 the node determines if there are power source ports connected to the node, i.e., which of the ports on the node are receiving power. Further, a determination is made whether the vehicle is in a standby or run status. Control proceeds to step 1304 where a check for faults occurs. This can be done by the techniques discussed above. In step 1306 when run voltage is detected, discovery of the data network is done by sending queries or messages on each of the data links and awaiting responses. After all responses have been received and the connections known, routing tables are developed to allow messages to be passed between the sensors, actuator and nodes. Upon initialization of the primary node, in one embodiment the node closest to the battery and with the lowest module number if two are equally distant, the primary node receives responses from each of the subservient or non-source nodes in step 1308. The responses include the power requirements of each node, that is, the power being directly supplied by the node itself. This is used in determining power routing and sharing. In step 1310, when all of the nodes have responded with their power requirements, a power routing and sharing calculation is performed in step 1312. The redundant power routes at this time are inhibited to stop potential circulating loop problems, and so on. In step 1314 a signal is provided that the network is ready to start so that the vehicle operations can begin. In step 1316 the various other applications or modules present in the vehicle initialize and communicate their successful startup. In step 1318 each of the nodes performs periodic power rediscovery to determine if the source of power has changed and to perform more fault checking to determine if a fault has developed. Once the network has completed the checking of step 1318, control returns to step 1318 on a periodic basis.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A system for balancing power flow in a vehicle comprising:
a plurality of nodes disposed at various locations within the vehicle, each node including:
a microcontroller;
at least two ports for coupling to different nodes, the port including power, ground and communications connections, with the communications connections coupled to the microcontroller; and
at least two power switches, each power switch having first and second power terminals and a control connection to control a connection between the first and second power terminals, each power switch having one power terminal coupled to an associated port and the other power terminals connected together and having the control terminal coupled to the microcontroller, with at least one of the nodes for connecting to a power source; and
a plurality of links interconnecting the plurality of nodes, each link containing power, ground and communication cables, the links adapted to connect to the ports of the nodes, at least one of the plurality of links being redundant to form a network with multiple paths,
wherein the microcontrollers of the nodes communicate with each other and wherein one microcontroller is a primary microcontroller and is adapted to control the power switches in the nodes to balance current flow from the power source through the network of nodes.

2. The system of claim 1, wherein each power switch further has a current sensor coupled to the microcontroller in the node,
wherein each microcontroller monitors the current in each power switch and provides the current values for each power switch to the primary microcontroller, and
wherein the primary microcontroller utilizes received current values to balance current flow.

3. The system of claim 2, wherein each microcontroller monitors the currents in the node and assists in determining if a fault is occurring, and
wherein each microcontroller disables an appropriate power switch in the node to remedy a fault.

4. The system of claim 3, wherein the primary microcontroller rebalances current flow after a fault is remedied.

5. The system of claim 3, wherein each microcontroller cooperates with the primary microcontroller to determine fault location, and
wherein the primary microcontroller instructs the appropriate microcontroller to disable the appropriate power switch.

6. The system of claim 1, wherein the primary microcontroller determines if a node has failed and rebalances current flow to remedy such failure.

7. The system of claim 1, wherein communication is performed over the power and the communication and power connections are merged.

8. A node for controlling power flow in a vehicle comprising:
a microcontroller adapted to determine if it is a primary microcontroller in a plurality of coupled nodes when none of the coupled nodes are in a failed condition;
at least two ports for coupling to different nodes, the port including power, ground and communications connections, with the communications connections coupled to the microcontroller;
at least two power switches, each power switch having first and second power terminals and a control connection to control a connection between the first and second power terminals, each power switch having one power terminal coupled to an associated port and the other power terminals connected together and having the control terminal coupled to the microcontroller; and
a current sensor for each power switch coupled to the microcontroller.

9. The node of claim 8, wherein the microcontroller monitors the currents in the node and assists in determining if a fault is occurring, and
wherein the microcontroller disables an appropriate power switch in the node to remedy a fault.

10. The node of claim 9, wherein the microcontroller provides fault information over at least one communication connection.

11. The node of claim 8, wherein the microcontroller provides sensed current values over at least one communication connection.

12. The node of claim 8, wherein the microcontroller is adapted to receive instructions over a communications connection directing it to control a power switch and the microcontroller appropriately controls such power switch.

13. The node of claim 8, wherein communication is performed over the power and the communication and power connections are merged.

14. A method for balancing power flow in a vehicle comprising:
providing a plurality of nodes disposed at various locations within the vehicle, each node including:
a microcontroller;
at least two ports for coupling to different nodes, the port including power, ground and communications connections, with the communications connections coupled to the microcontroller; and
at least two power switches, each power switch having first and second power terminals and a control connection to control a connection between the first and second power terminals, each power switch having one power terminal coupled to an associated port and the other power terminals connected together and having the control terminal coupled to the microcontroller, with at least one of the nodes for connecting to a power source;
providing a plurality of links interconnecting the plurality of nodes, each link containing power, ground and communication cables, the links adapted to connect to the ports of the nodes, at least one of the plurality of links being redundant to form a network with multiple paths;
the microcontrollers of the nodes communicating with each other; and
designating one microcontroller as a primary microcontroller which controls the power switches in the nodes to balance current flow from the power source through the network of nodes.

15. The method of claim 14, wherein each power switch further has a current sensor coupled to the microcontroller in the node, the method further comprising:
each microcontroller monitoring the current in each power switch and providing the current values for each power switch to the primary microcontroller; and
the primary microcontroller utilizing received current values to balance current flow.

16. The method of claim 15, the method further comprising:
each microcontroller monitoring the currents in the node and assisting in determining if a fault is occurring; and
each microcontroller disabling an appropriate power switch in the node to remedy a fault.

17. The method of claim 16, the method further comprising:
the primary microcontroller rebalancing current flow after a fault is remedied.

18. The method of claim 16, the method further comprising:
each microcontroller cooperating with the primary microcontroller to determine fault location; and
the primary microcontroller instructing the appropriate microcontroller to disable the appropriate power switch.

19. The method of claim 14, the method further comprising:
the primary microcontroller determining if a node has failed and rebalancing current flow to remedy such failure.

20. The method of claim 14, wherein communication is performed over the power and the communication and power connections are merged.
